(19) United States
(12) Patent Application Publication
(10) Pub. No.: US 2015/0268202 A1
(43) Pub. Date: Sep. 24, 2015

(54) Pump Priming Systems

(71) Applicant: ALLTECH ASSOCIATES, INC., Columbia, MD (US)

(72) Inventors: Romulus Gaita, Des Plaines, IL (US); Washington Mendoza, Lake in the Hills, IL (US); James Anderson, JR., Arlington Heights, IL (US); Melissa Golde, Rolling Meadows, IL (US); Raaidah Saari-Nordhaus, Antioch, IL (US)

(73) Assignee: Alltech Associates, Inc., Columbia, MD (US)

(21) Appl. No.: 14/438,485

(22) PCT Filed: Oct. 25, 2013
(86) PCT No.: PCT/US2013/066826

§ 371 Date: Apr. 24, 2015

Related U.S. Application Data
(60) Provisional application No. 61/718,438, filed on Oct. 25, 2012.

(51) Int. Cl. G01N 30/32; F04B 41/02; F04B 41/06; B01D 15/08

(52) U.S. Cl. CPC G01N 30/32; B01D 15/08; F04B 41/02; F04B 41/06

(57) ABSTRACT

Pump priming systems and chromatography systems containing the same are, disclosed. Methods of making and methods of using pump priming systems are also disclosed. In conventional chromatography instrumentation, pump priming is performed in a manual mode where the operator manually opens a mechanical valve and uses a syringe to move liquid through the pump until the lines and the pump are filled with liquid.

### FIELD OF THE INVENTION

The present invention is directed to pump priming systems and chromatography systems containing an pump priming system, methods of making pump priming systems, and methods of using pump priming systems.

### BACKGROUND OF THE INVENTION

In conventional chromatography instrumentation, pump priming is performed in a manual mode where the operator manually opens a mechanical valve and uses a syringe to move liquid through the pump until the lines and the pump are filled with liquid. Manually priming the pump in conventional chromatography instrumentation has one or more shortcomings including, but not limited to, (1) man hours needed to (i) open a mechanical valve, (ii) prepare a syringe, and (iii) utilize the syringe to move liquid through the pump until the lines and the pump are filled with liquid; (2) potential human error relating to (i) manually opening the mechanical valve, (ii) manually preparing the syringe, and (iii) manually utilizing the syringe to move liquid through the pump until the lines and the pump are filled with liquid; (3) uncertainty with regard to the effectiveness of the manual pump priming operation; and (4) potential inconsistency between manual pump pruning operations from one pump to another pump.

There is a need in the art to improve a pump priming operation so as to remove one of more of the above-mentioned shortcomings.

### SUMMARY OF THE INVENTION

The present invention addresses some of the difficulties and problems discussed above by the discovery of a pump priming system suitable for use in chromatography system. The disclosed pump priming systems enable a more efficient, productive and/or consistent pump priming operation due to one or more of the following advantages over conventional chromatographic operations: (1) elimination of man hours needed to (i) manually open a mechanical valve, (ii) manually prepare a syringe, and (iii) manually utilize the syringe to move liquid through the pump until the lines and the pump are filled with liquid; (2) potentially remove human error relating to (i) manually opening the mechanical valve, (ii) manually preparing the syringe, and (iii) manually utilizing the syringe to move liquid through the pump until the lines and the pump are filled with liquid; (3) potentially remove uncertainty with regard to the effectiveness of a given pump priming operation and (4) potentially remove inconsistency between pump priming operations from one pump to another pump.

In one exemplary embodiment, the pump priming system of the present invention comprises a priming device in fluid communication with (i) at least one solvent reservoir, (ii) at least one solvent pump, (iii) an optional solvent selection device positioned between each solvent reservoir and each solvent pump, and (iv) a valve positioned between the priming device and the at least one solvent pump; and an optional microprocessor with user interface, the microprocessor being programmed to (i) receive input from a user, and in response to receiving input from the user, (ii) initiate a pump priming process, wherein fluid from at least one of the at least one solvent reservoir is moved through the at least one solvent pump via the priming device.

The present invention is further directed to chromatography systems comprising an automated pump priming system. In one exemplary embodiment, the chromatography system of the present invention comprises at least one solvent reservoir; at least one solvent pump, each of which is in fluid communication with the at least one solvent reservoir; an optional solvent selection device positioned between each solvent reservoir and each solvent pump; a priming device in fluid communication with (i) the at least one solvent reservoir, (ii) the at least one solvent, pump, and (iii) the optional solvent selection device positioned between each solvent reservoir and each solvent pump; a valve positioned between the priming device and the at least one solvent pump; and an optional microprocessor with user interface, the microprocessor being programmed to (i) receive input from a user, and in response to receiving input from the user, (ii) initiate a pump priming process, wherein fluid from at least one of the at least one solvent reservoir is moved through the at least one solvent pump via the priming device.

The present invention is even further directed to methods of priming a pump. In one exemplary embodiment, the method of priming a pump comprises moving a pump priming fluid from at least one solvent reservoir through at least one solvent pump via a priming device. The disclosed methods of priming a pump may further comprise one or more additional steps, such as, optionally opening a solvent selection device positioned between one of the at least one solvent reservoir and a first solvent pump; opening a valve positioned between the priming device and the at least one solvent pump; and activating the priming device. In some embodiments, the disclosed method of priming a pump comprises priming a pump in a chromatography system.

The present invention is also directed to kits for incorporating a pump priming system into an existing chromatography system. In one exemplary embodiment, the kit for incorporating a pump priming system into an existing chromatography system comprises a priming device; a valve positioned between the priming device and at least one solvent pump of the existing chromatography system; and an optional software update for a microprocessor of the existing chromatography system, the software update, when loaded onto the microprocessor, enabling the microprocessor to perform one or more of the herein disclosed methods of priming a pump.

The present invention is additionally directed to methods of making a chromatography system. In one exemplary embodiment, the method of making a chromatography system comprises incorporating (i) at least one solvent reservoir; (ii) at least one solvent pump, each of which is in fluid communication with the at least one solvent reservoir; (iii) an optional solvent selection device positioned between each solvent reservoir and each solvent pump; (iv) a priming device in fluid communication with the at least one solvent reservoir, the at least one solvent pump, and the optional solvent selection device; (v) a valve positioned between the priming device and the at least one solvent pump; and (vi) an optional microprocessor with user interface into the chromatography system, wherein the microprocessor is programmed to (1) receive input from a user, and in response to receiving input from the user, (2) initiate a pump priming process, wherein fluid from at least one of the at least one solvent reservoir is moved through the at least one solvent pump via the priming device.

These and other features and advantages of the present invention will become apparent after a review of the following detailed description of the disclosed embodiments and the appended claims.

### BRIEF DESCRIPTION OF THE FIGURES

FIG. 1 depicts a view of an exemplary automated pump priming system of the present invention;

FIG. 2 depicts a view of an exemplary chromatography system comprising the exemplary automated pump priming system shown in FIG. 1;

FIG. 3 depicts a view of an exemplary user interface display suitable for use in the exemplary chromatography system shown in FIG. 2; and

FIGS. 4A-4C depict a flowchart showing exemplary steps for utilizing the exemplary automated pump priming system shown in FIG. 1 (FIGS. 4A-4B) and in a chromatography system such as the exemplary chromatography system shown in FIG. 2 (FIGS. 4A and 4C).

### DETAILED DESCRIPTION OF THE INVENTION

To promote an understanding of the principles of the present invention, descriptions of specific embodiments of the invention follow and specific language used to describe the specific embodiments. It will nevertheless be understood that no limitation of the scope of the invention is intended by the use of specific language. Alterations, further modifications, and such further applications of the principles of the present invention discussed are contemplated as would normally occur to one ordinarily skilled in the art to which the invention pertains.

It must be rioted that as used herein and in the appended claims, the singular forms “a”, “and”, and “the” include plural referents unless the context clearly dictates otherwise. Thus, for example, reference to “an oxide” includes a plurality of such oxides and reference to “oxide” includes reference to one or more oxides and equivalents thereof known to those skilled in the art, and so forth.

“About” modifying, for example, the quantity of an ingredient in a composition, concentrations, volumes, process temperatures, process times, recoveries or yields, flow rates, and like values, and ranges thereof, employed in describing the embodiments of the disclosure, refers to variation in the numerical quantity that may occur, for example, through typical measuring and handling procedures; through inadvertent error in these procedures; through differences in the ingredients used to carry out the methods; and like proximate considerations. The term “about” also encompasses amounts that differ due to aging of a formulation with a particular initial concentration or mixture, and amounts that differ due to mixing or processing a formulation with a particular initial concentration or mixture. Whether modified by the term “about” the claims appended hereto include equivalents to these quantities.

As used herein, the term “chromatography” means the process of passing a mixture dissolved in a mobile phase through a stationary phase chromatography media) housed in a column or cartridge or other container, which separates a target molecule from other molecules in the mixture and allows it to be isolated. Depending upon the type of chromatography used, the target molecule may be adsorbed onto the stationary phase while the undesired components are passed through the device, or vice versa. The term “liquid chromatography” is a form of chromatography where a liquid is used as the mobile phase and a solid or a liquid on a solid support as the stationary phase. The term “flash chromatography” means liquid chromatography that is conducted under a positive pressure (e.g., up to 300 psi). The term “high performance liquid chromatography” (HPLC) means liquid chromatography that is conducted under a high positive pressure (e.g., up to 5000 psi). The term “preparatory chromatography” means HPLC for the isolation and purification of a target compound or molecule. The mobile phase may include one or more solvents that include the target molecule.

As used herein, the term “fluid” means any substance that flows or deforms under an applied shear stress. Fluids comprise liquids, gases, plasma, and combinations thereof (e.g., supercritical fluid).

As used herein, the term “pump” means a device used to move fluids by mechanical action, such as direct lift, displacement, and gravity pumps. The mechanical action is often reciprocating or rotary, which may be created by manual operation, electricity, an engine, or other energy, such as wind or other energy.

As used herein, the term “valve” means a device that regulates, directs, or controls the flow of a fluid by opening, closing, restricting or moving the fluid, and may be categorized as passive and active valves. Passive valves operate without the need for external energy sources, but instead exploit energies already present in the system (often, pressure differentials). Active valves, on the other hand, require external energy, and an actuation principle where the external energy is transducted to typically a mechanical action that either restricts or opens for the passage of fluids. As used herein, the term “splitter valve” means a device that splits the flow of a fluid stream or moves fluid from one stream to another stream, and includes passive valves (e.g., tee, splitters, and the like), and active valves (e.g., shuttle valves, splitter pumps, and the like).

The present invention is directed to pump priming systems and chromatography systems containing a pump priming system. The present invention is further directed to methods of making pump pinning systems and chromatography systems, as well as methods of using pump priming systems and chromatography systems. A description of exemplary pump priming systems, exemplary chromatography systems, methods of making pump priming systems and chromatography systems, and methods of using pump priming systems and chromatography systems is provided below.

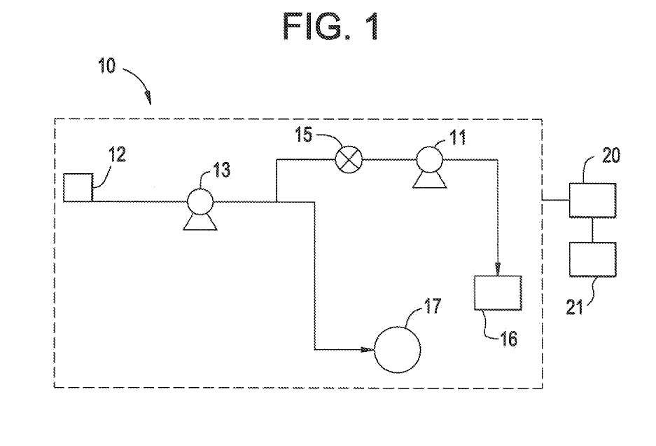

FIG. 1 provides a view of an exemplary pump priming system 10 of the present invention. As shown in FIG. 1, exemplary pump priming system 10 comprises a at least one priming device 11 in fluid communication with (i) at least one solvent reservoir 12, (ii) at least one solvent pump 13, (iii) an optional manifold valve (not shown) positioned between each solvent reservoir 12 and each solvent pump 13, and (iv) at least one valve 15 positioned between at least one priming device 11 and at least one solvent pump 13. In some desired embodiments, priming device 11 comprises a vacuum pump, positive displacement pump, impulse pump, valve-less pump, velocity pump or the like. Even though FIG. 1 depicts only one priming device 11, one solvent reservoir 12, one valve 15, and one solvent pump 13, there may be multiple priming devices, solvent reservoirs, or valves and solvent pumps, which may be in fluid communication with each other in series or parallel configuration, or in fluid communication with a solvent section device so as to minimize the number of components required in the pump priming system 10.

Exemplary pump priming system 10 may further comprises a microprocessor 20 with user interface 21, wherein microprocessor 20 is programmed to (i) receive input from a user (not shown), and in response to receiving input from the user, (ii) initiate a pump priming process, wherein pump priming fluid (not shown) from at least one of the at least one solvent reservoir 12 is moved (e.g., pulled or pushed) through at least one solvent pump 13 via priming device 11. As shown in FIG. 1, once pump priming fluid (not shown) flows through priming device 11, the pump priming fluid is collected in a reservoir 16 (e.g., a waste reservoir). Even though a microprocessor is utilized in this exemplary embodiment, the pump priming system may be operated manually using switches to turn the pumps on and off, and to open and close the valves.

As shown in FIG. 1, exemplary pump priming system 10 comprises one solvent reservoir 12; however, it should be noted that pump priming systems of the present invention may comprise at least one solvent reservoir 12, typically, two or more solvent reservoirs 12. Further, exemplary pump priming system 10 comprises a single solvent pump 13; however, it should be noted that pump priming systems of the present invention may comprise at least one solvent pump 13, typically, two or more solvent pumps 13. In addition, priming device 11 may be located upstream of, or prior to, solvent pump 13 instead of downstream as depicted in FIG. 1. In one embodiment, the system includes at least one solvent pump for each solvent reservoir. Alternatively, the system may include at least one solvent pump in combination with a solvent selection device that allows one or more solvents to be pumped through each solvent pump.

In the embodiment where a microprocessor 20 is utilized, it may be combined with the user interface 21, which may comprise any computing device, and may be connected to interact with exemplary pump priming system 10 using known connection techniques (e.g., wired connections, wireless connections, etc.). Upon receiving input from a user (not shown), microprocessor 20 is programmed to (1) open a priming device valve (e.g., solenoid valve 15), (2) open a first manifold valve positioned between a solvent reservoir and a first solvent pump (e.g., one of manifold valves between one of solvent reservoirs 12 and solvent pump 13), and (3) activate priming device 11.

In some embodiments, microprocessor 20, upon receiving input from a user (not shown), is further programmed to perform one or more of the following tasks: (4) run priming device 11 for a desired length of time (e.g., for up to 60 or 120 seconds), (5) deactivate priming device 11, (6) close priming device valve 15, (7) close the first manifold valve (e.g., one of manifold valves between one of solvent reservoirs 12 and solvent pump 13), (8) initiate a pump priming test for solvent pump 13, and if solvent pump 13 does not pass the pump priming test, (9) repeat steps (1) to (8) or warns the user.

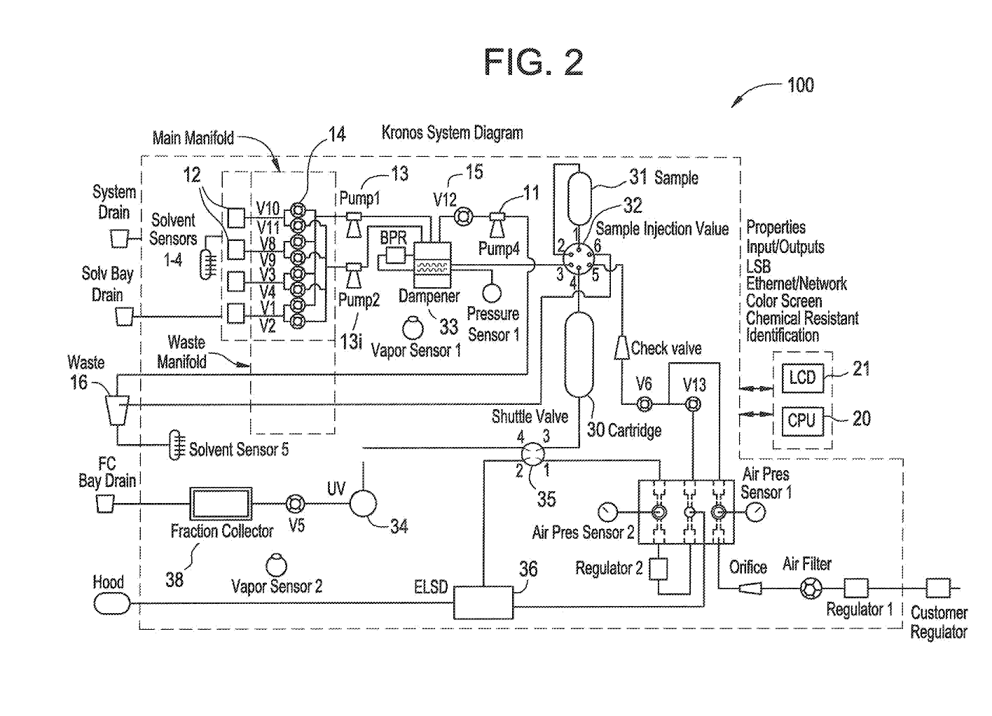

In embodiments wherein a second solvent pump is present (see, for example, exemplary chromatography system 100 in FIG. 2), microprocessor 20, upon receiving input from a user (not shown), is further programmed to (10) open priming device valve 15, (11) open a second manifold valve (e.g., any one of manifold valves) positioned between a solvent reservoir (e.g., any one of solvent reservoir 12) and the second solvent pump (see, for example, second pump 131 in FIG. 2), (12) activate priming device 11, (13) run priming device 11 for a desired length of time, (14) deactivate priming device 11, (15) close priming device valve 15, (17) initiate a pump priming test for the second solvent pump, and if the second solvent pump does not pass the pump priming test, (18) repeat steps (10) to (17) or warns the user.

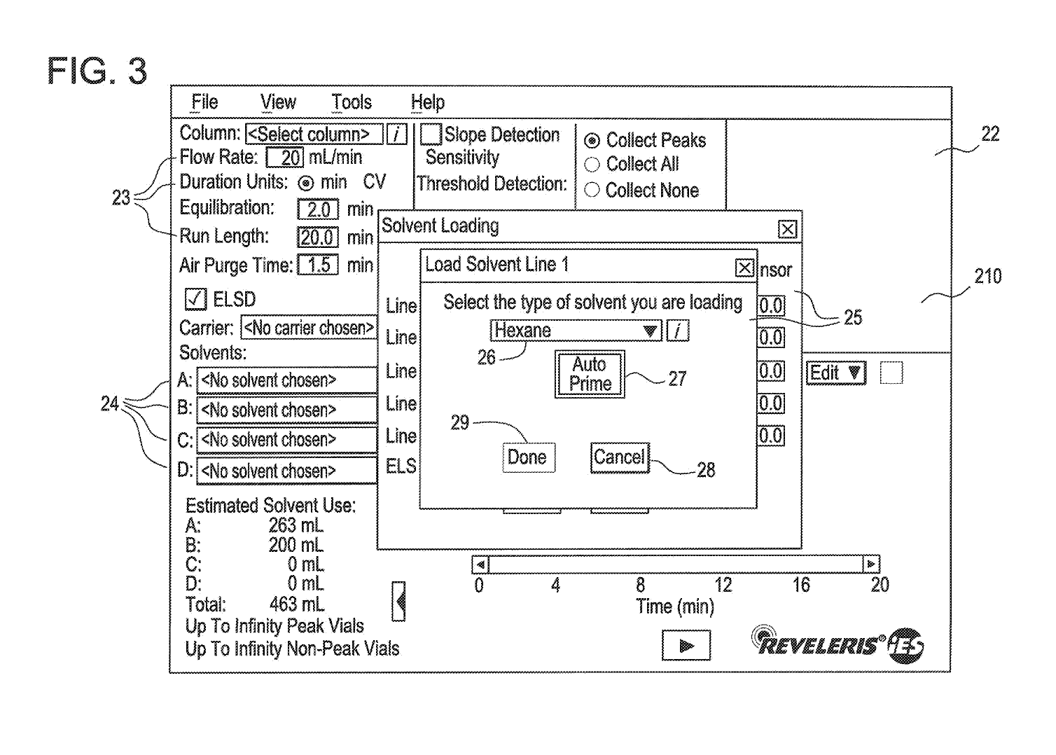

Desirably, microprocessor 20 is programmed to provide one or more prompts to a user (not shown) via a user interface, such as user interface 21 comprising user interface display 210 (see FIG. 3). User interface display 210 may display one or more prompts including, but not limited to, prompts comprising (1) an auto prime initiation prompt, (2) a solvent selection prompt, (3) a pump priming test initiation prompt, (4) a solvent pump or reservoir selection prompt, (5) a pump priming completion prompt, or (6) any combination of prompts (1) to (5).

Exemplary pump priming system 10 shown in FIG. 1 may be incorporated into a variety of systems, wherein fluid from at least one solvent reservoir 12 is pumped into a given system 17 as shown in FIG. 1. In one desired embodiment of the present invention, exemplary pump priming system 10 shown in FIG. 1 is incorporated into a chromatography system such as exemplary chromatography system 100 shown in FIG. 2.

As shown in FIG. 2, exemplary chromatography system 100 comprises the following components: priming device 11; solvent reservoirs 12; first and second solvent pumps 13 and 131; manifold valves; priming device valve 15; and microprocessor 20 with user interface 21. Exemplary chromatography system 100 further comprises chromatography cartridge 30; sample injection port 31; sample injection valve 32; dampener 33; UV detector 34, active splitter valve (e.g., shuffle valve or splitter pump) 35; ELSD 36; fluid source 37; fraction collector 38; and waste collector/reservoir 16.

As shown in FIG. 2, chromatography systems of the present invention, such as exemplary chromatography system 100, comprise at least one solvent reservoir 12 (e.g., exemplary chromatography system 100 comprises four solvent reservoirs 12); at least one solvent pump 13 (e.g., exemplary chromatography system 100 comprises two solvent pumps 13 and 131), each of which is in fluid communication with at least one solvent reservoir 12; a manifold valve (e.g., exemplary chromatography system 100 comprises eight manifold valves) positioned between each solvent reservoir 12 and each solvent pump 13 and 131; a priming device 15 in fluid communication with (i) at least one solvent reservoir 12, (ii) at least one solvent pump 13 and 131, and (iii) manifold valve positioned between each solvent reservoir 12 and each solvent pump 13 or 131; a priming device valve 15 positioned between priming device 11 and at least one solvent primp 13 or 131; a microprocessor 20 with user interface (e.g., display 210), microprocessor 20 being programmed to (i) receive input from a user (not shown), and in response to receiving input from the user, (ii) initiate a pump priming process, wherein fluid from at least one of the at least one solvent reservoir 12 is moved through at least one solvent pump 13 or 131 via priming device 11; and at least one chromatography column/cartridge 30 in fluid communication with the at least one solvent reservoir 12.

Chromatography systems of the present invention, such as exemplary chromatography system 100, may comprise at least one solvent reservoir 12. As shown in FIG. 2, exemplary chromatography system 100 comprises four solvent reservoirs 12. Further, chromatography systems of the present invention may comprise at least one solvent pump 13 or 131. As shown in FIG. 2, exemplary chromatography system 100 comprises two solvent pumps 13 and 131.

In an embodiment where a microprocessor 20 is utilized, the exemplary chromatography system 100, upon receiving input from a user (not shown), is desirably programmed to perform (i.e., cause to occur) one or more of the following steps: (1) open priming device valve 15; (2) open a first manifold valve positioned between a solvent reservoir 12 and a first solvent pump 13, (3) activate priming device 11; (4) run priming device 11 for a desired length of time (e.g., up to 60 or 120 seconds); (5) deactivate priming device 11; (6) close priming device valve 15; (7) close first manifold valve; (8) initiate a pump priming test for first solvent pump 13, and if first solvent pump 13 does not pass the pump priming test, (9) repeat steps (1) to (8) or warns the user. For example, microprocessor 20 may be programmed to repeat steps (1) to (8) one or more times, typically, at least two times (e.g. up to 10 times), and thereafter inform the user that an error or system problem has occurred.

When a given chromatography system, such as exemplary chromatography system 100, comprises a second solvent pump (e.g., second solvent pump 131), microprocessor 20, upon receiving input from a user (not shown), is further programmed to perform (i.e., cause to occur) one or more of the following steps: (10) open priming device valve 15; (11) open a second manifold valve positioned between a solvent reservoir 12 (i.e., the same solvent reservoir 12 as used to prime solvent pump 13 or a different solvent reservoir 12) and second solvent pump 131; (12) activate priming device 11; (13) run priming device 11 for a desired length of time; (14) deactivate priming device 11; (15) close priming device valve 15; (17) initiate a pump priming test for second solvent pump 131; and if second solvent pump 131 does not pass the pump priming test, (18) repeat steps (10) to (17) or warns the user. For example, microprocessor 20 may be programmed to repeat steps (10) to (17) one or more times, typically, at least two times (e.g. up to ten times).

Microprocessor 20 of exemplary chromatography system 100 is further desirably programmed to provide one or more prompts to a user (not shown) via user interface 21 (e.g., a computer display 210). The one or more prompts may comprise, but are not limited to, (1) an auto prime initiation prompt, (2) a solvent selection prompt, (3) a pump priming test initiation prompt, (4) a solvent pump or reservoir selection prompt, (5) a pump priming completion prompt, or (6) any combination of prompts (1) to (5).

Priming device 11 of exemplary chromatography system 100 may be any type of pump that moves a pump priming fluid (not shown) from at least one of the at least one solvent reservoir 12 through the at least one solvent pump 13 and/or 131 (e.g. sequentially as discussed above). In some desired embodiments, priming device 11 of exemplary chromatography system 100 comprises a vacuum pump, positive displacement pump, impulse pump, valve-less pump, velocity pump or the like.

The present invention is further directed to methods of priming a pump, such as solvent pump 13 shown in FIG. 1 or 2. In one exemplary embodiment, the method of priming a pump comprises moving a pump priming fluid (e.g., a solvent) from a least one solvent reservoir 12 through at least one solvent pump 13 via a priming device 11. The disclosed methods of priming a pump may further comprise one or more additional steps. Suitable additional steps include, but are not limited to, (1) opening a first manifold valve positioned between one of the at least one solvent reservoir 12 and a first solvent pump 13 of the at least one solvent pump (i.e., at least one solvent pump 13 and 131); (2) opening a priming device valve 15 positioned between the priming device 11 and the at least one solvent pump (i.e., first solvent pump 13); and (3) activating priming device 11.

The disclosed methods of priming a pump may further comprise one or more additional steps including, but not limited to, (4) deactivating priming device 11 after a pump priming period; (5) initiating a pump priming test on first solvent pump 13; and if first solvent pump 13 does not pass the pump priming test, repeating steps (1) to (5) at least one time (e.g., up to ten times). In some embodiments, the initiating a pump priming test step is performed a maximum of two times, three times, four times, or more.

The disclosed methods of priming a pump of the present invention may further comprise one or more additional steps including those in response to receiving one or more inputs into user interface 21 of microprocessor 20. In some embodiments, in response to receiving one or more inputs from a user (not shown) into user interface 21 of microprocessor 20, the disclosed methods include one or more of the following steps: (1) initiating the method; (2) opening the priming device valve 15; (3) opening a first manifold valve; (4) activating priming device 11; (5) running priming device 11 for a desired length of time (e.g., any desired time period, for example, 60 seconds); (6) deactivating priming device 11; (7) closing priming device valve 15; and (9) initiating a pump priming test for the first solvent pump 13; and if the first solvent pump 13 does not pass the pump priming test, (10) repeating steps (2) to (9) or warns the user.

When a given system comprises a second solvent pump, such as in exemplary chromatography system 100, in response to receiving one or more inputs from a user (not shown) into user interface 21 of microprocessor 20, the disclosed methods may include one or more of the following additional steps: (11) opening priming device valve 15; (12) opening a second manifold valve positioned between a solvent reservoir 12 (e.g., any one of solvent reservoirs 12 shown in FIG. 2) and the second solvent pump 131; (13) activating priming device 11: (14) running priming device 11 for a desired length of time; (15) deactivating priming device 11; (16) closing priming device valve 15; (18) initiating a pump priming test for the second solvent pump 131; and if the second solvent pump 131 does not pass the pump priming test, (19) repeat steps (11) to (18) or warns the user.

The methods of the present invention may further comprise providing one or more prompts to a user (not shown) via user interface 21 of microprocessor 20. The one or more prompts may comprise, but are not limited to, (1) an auto prime initiation prompt, (2) a solvent selection prompt, (3) a pump priming test initiation prompt, (4) a solvent pump or reservoir selection prompt, (5) a pump priming completion prompt, or (6) any combination of prompts (1) to (5).

In one desired embodiment of the present invention, the method of priming a pump comprises priming a pump in a chromatography system, such as exemplary chromatography system 100 shown in FIG. 2. In these embodiments, the method may comprise moving a pump priming fluid (not shown; e.g., a solvent) from one of the at least one solvent reservoir 12 through one of the at least one solvent pump 13 or 131 via priming device 11. In these embodiments, the method may further comprise running a solvent (not shown) from the at least one solvent reservoir 12 through at least one chromatography column/cartridge 39 in fluid communication with the at least one solvent reservoir 12.

The present invention is further directed to kits that can be used to incorporate a pump priming system, such as exemplary pump priming system 10 shown in FIG. 1, into an existing chromatography system. In one exemplary embodiment, the kit for incorporating a pump priming system into an existing chromatography system comprises a priming device 11; a priming device valve 15 positionable between priming device 11 and at least one solvent pump (e.g., solvent pump 13 and/or 131) of the existing chromatography system; and a software update for a microprocessor of the existing chromatography system, the software update, when loaded onto the microprocessor, enabling the microprocessor to perform one or more of the herein disclosed methods and method steps of priming a pump. Such kits may be used to retrofit existing chromatography systems, such as the REVELERIS® Flash Chromatography System available from Alltech Associates, Inc.

The present invention is even further directed to methods of making a chromatography system, such as exemplary chromatography system 100 shown in FIG. 2. In some embodiments, the method of making a chromatography system comprises incorporating the herein-described pump priming system (e.g., exemplary pump priming system 10 of FIG. 1) into an existing chromatography system (e.g., using a kit as discussed above).

In other embodiments, the method of making a chromatography system comprises incorporating (i) at least one solvent reservoir 12; (ii) at least one solvent pump 13 and 131, each of which is in fluid communication with the at least one solvent reservoir 12; (iii) a manifold valve positioned between each solvent reservoir 12 and each solvent pump 13 and 131; (iv) a priming device 11 in fluid communication with the at least one solvent reservoir 12, the at least one solvent pump 13 and 131, and the manifold valve; (v) a priming device valve 15 positioned between the priming device 11 and the at least one solvent pump 13 and 131; and (vi) a microprocessor 20 with user interface 21 into the chromatography system (e.g., exemplary chromatography system 100), wherein the microprocessor 20 is programmed to (1) receive input from a user (not shown), and in response to receiving input from the user, (2) initiate a pump priming process, wherein fluid (not shown) from at least one of the at least one solvent reservoir 12 is moved through the at least one solvent pump 13 or 131 via the priming device 11.

The method of making a chromatography system may further comprise incorporating a microprocessor (e.g., exemplary microprocessor 20) into the chromatography system, wherein the microprocessor is programmed to perform one or more of the following tasks/operations: (1) open a priming device valve 15, (2) open a first manifold valve positioned between a solvent reservoir 12 and a first solvent pump 13; (3) activate the priming device 11 upon receiving input from a user; (4) run the priming device 11 for a desired length of time (5) deactivate the priming device 11; (6) close the priming device valve 15; and (8) initiate a pump priming test for the first solvent pump 13 upon receiving input from a user; and if the first solvent pump 13 does not pass the pump priming test, (9) repeat steps (1) to (8) or warns the user. Typically, when repeated, steps (1) to (8) are repeated a maximum number of times (e.g., up to ten times), such as a maximum of two times. It the first solvent pump 13 does not pass the pump priming test after a set number of times, the pump priming cycle/run is stopped to investigate possible problems within the pump priming system.

When a given chromatography system comprises two or more solvent pumps, the method of making a chromatography system may further comprise incorporating a microprocessor (e.g., exemplary microprocessor 20) into the chromatography system, wherein the microprocessor is programmed to perform one or more of the following additional tasks/operations: (10) open the priming device valve 15; (11) open a second manifold valve positioned between a solvent reservoir 12 and the second solvent pump 131; (12) activate the priming device 11; (13) run the priming device 11 for a desired length of time, (14) deactivate the priming device 11, (15) close the priming device valve 15; (17) initiate a pump priming test for the second solvent pump 131; and if the second solvent pump 131 does not pass the pump priming test (18) repeat steps (10) to (17) or warns the user.

The method of making a chromatography system may further comprise incorporating a microprocessor (e.g., exemplary microprocessor 20) into the chromatography system, wherein the microprocessor is programmed to provide one or more prompts to a user (not shown) via the user interface (e.g., interface 21 with display 210). The one or more prompts may comprise, but are not limited to (1) an auto prime initiation prompt, (2) a solvent selection prompt. (3) a pump priming test initiation prompt, (4) a solvent pump or reservoir selection prompt, (5) a pump priming completion prompt or (6) any combination of prompts (1) to (5).

The present invention is even further directed to methods of using a pump priming system in a chromatography system. In one exemplary embodiment, the method of using a pump priming system in a chromatography system comprises, in response to receiving input from a user (not shown), initiating a pump priming procedure comprising moving a pump priming fluid (not shown) from at least one solvent reservoir 12 through at least one solvent pump 13 or 131 via a priming device 11.

The method of using a pump priming system in a chromatography system may further comprise one or more of the following steps: opening a first manifold valve positioned between one of the at least one solvent reservoir 12 and a first solvent pump 13 of the at least one solvent pump (e.g., pumps 13 and 131): opening a priming device valve 15 positioned between the priming device 11 and the at least one solvent pump 13; activating the priming device 11, deactivating the priming device 11 after a pump priming period; initiating a pump priming test on the first solvent pump 13; and if the first solvent pump 13 does not pass the pump priming test, repeating the steps from opening of the manifold valve step to the deactivating step at least one time (e.g., initiating a repeat of the pump priming test step a maximum of two times, up to a maximum of ten times).

The method of using a pump priming system in a chromatography system may further comprise one or more of the following steps: in response to receiving one or more inputs into a user interface 21 of a microprocessor 20, (1) initiating the pump priming method; (2) opening the priming device valve 15; (3) opening the first manifold valve; (4) activating the priming device 11; (5) running the priming device 11 for a desired length of time; (6) deactivating the priming device 11; (7) closing the priming device valve 15; (9) initiating a pump priming test for the first solvent pump 13, and if the first solvent pump 13 does not pass the pump priming test, (10) repeating steps (2) to (9), or warn the user.

In chromatography systems with two or more solvent pumps, the methods of using a pump priming system in a chromatography system may further comprise, in response to receiving one or more inputs into a user interface 21 of a microprocessor 20, one or more additional steps such as (11) opening the priming device valve 15; (12) opening a second manifold valve positioned between a solvent reservoir 12 and the second solvent pump 131; (13) activating the priming device 11; (14) running the priming device 11 for a desired length of time; (15) deactivating the priming device 11; (16) closing the priming device valve 15; (18) initiating a pump priming test for the second solvent pump 131; and if the second solvent pump 131 does not pass the pump priming test, (19) repeat steps (11) to (18), or warns the user.

The methods of using a pump priming system in a chromatography system may further comprise responding to one or more prompts provided by user interface 21 of a microprocessor 20. The one or more prompts may comprise (1) an auto prime initiation prompt, (2) a solvent selection prompt, (3) a pump priming test initiation prompt, (4) a solvent pump or reservoir selection prompt, (5) a pump priming completion prompt, or (6) any combination of prompts (1) to (5). In addition, the methods of using a pump priming system in a chromatography system may further comprise running a solvent from the at least one solvent reservoir 12 through at least one chromatography column 30 in fluid communication with the at least one solvent reservoir 12.

In order to provide interaction between a user (not shown) and a given pump priming system, the pump priming system may comprise a user interface, such as user interface 21 of microprocessor 20 with display 210 as shown in FIG. 3. As shown in FIG. 3, display 210 comprises main menu display 22 with various parameters/options 23 (e.g., flow rate, duration units, run length, etc.) that a user may choose prior to operating the system (e.g., exemplary chromatography system 100 shown in FIG. 2). Main menu display 22 also comprises solvent options 24, wherein a user can input one or more solvent types corresponding to a given solvent reservoir (e.g., solvent reservoirs 12 shown in FIG. 2).

Although not shown in FIGS. 1-3, it should be understood that in addition to display 210, user interface 21 of microprocessor 20 may also comprise other user interface components including, but not limited to, a keyboard, a mouse, a laptop, a desktop computer, a wireless router, etc. Further, display 210 may comprise a touch-screen that enables a user to interact with microprocessor 20 without the need of a keyboard and/or mouse when choosing one or more options shown, for example, on main menu display 22 in FIG. 3.

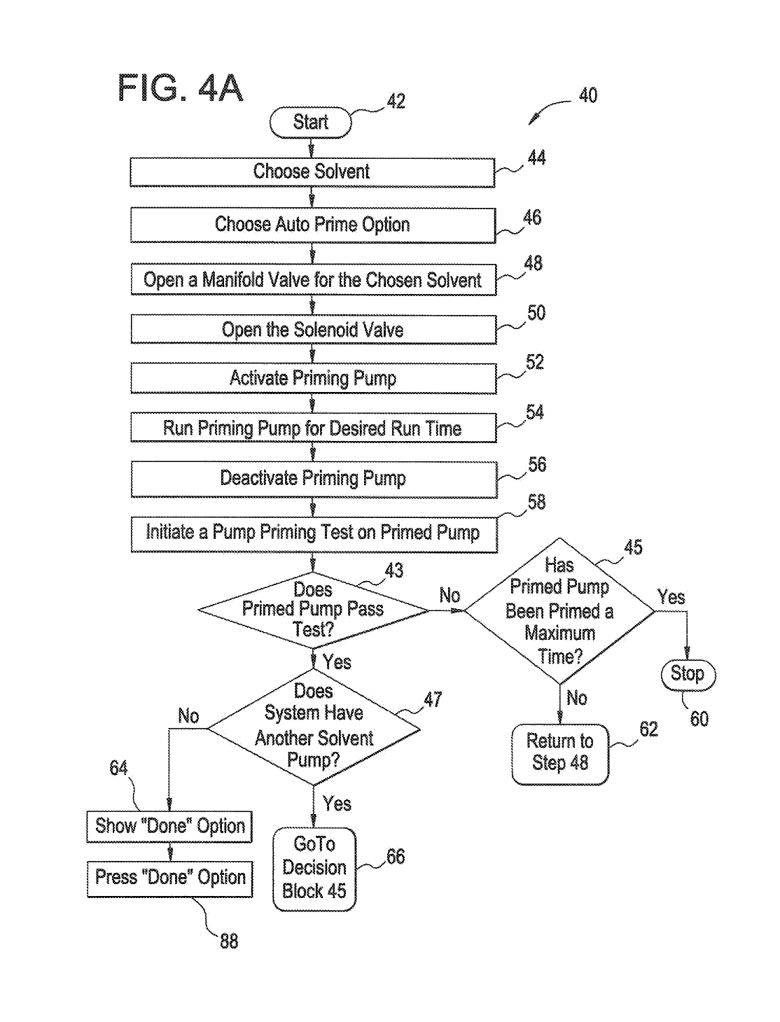

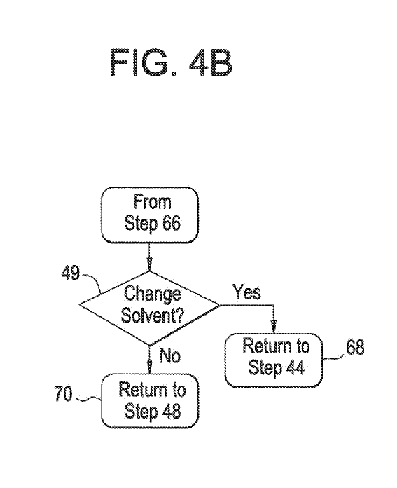

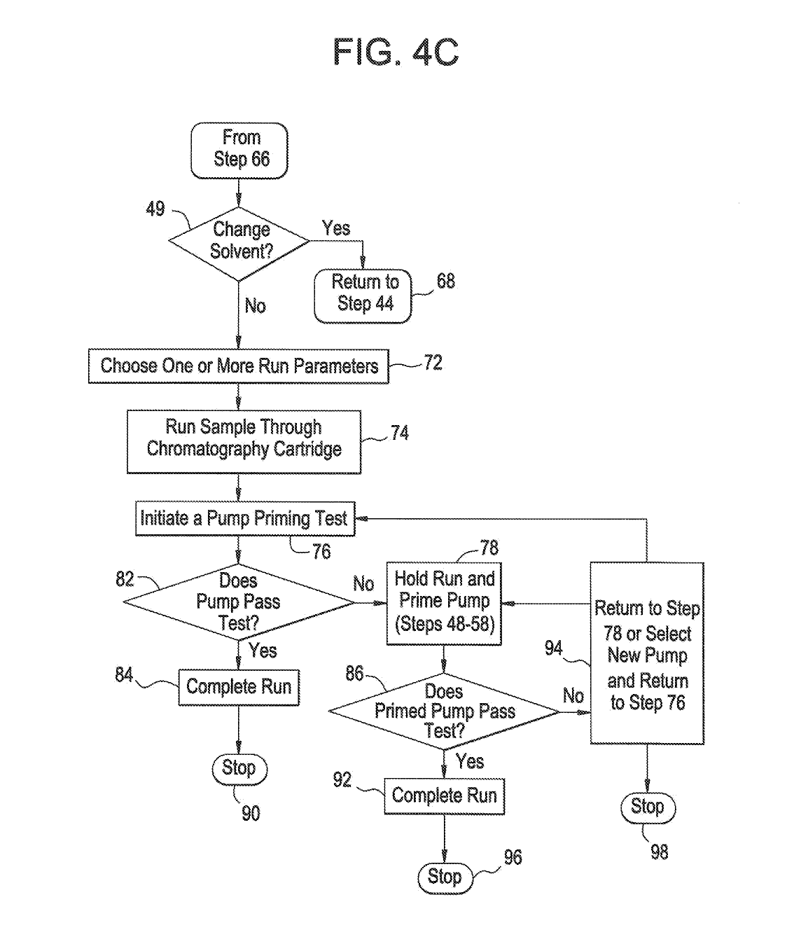

As disclosed herein, the methods of using the disclosed pump priming systems of the present invention may comprise a combination of various steps. FIGS. 4A-4C depict a flowchart showing a variety of exemplary steps for utilizing a pump printing system. It should be noted that although the flowchart shown in FIGS. 4A-4C depict numerous steps of exemplary method 40 in sequence with one another, methods of using the disclosed pump priming systems of the present invention may comprise any one or any combination of two or more of the steps shown in exemplary method 40, alone or in combination with other steps not shown in FIGS. 4A-4C.

As shown in FIG. 4A, exemplary method 40 begins at start box 42 and proceeds to step 44, wherein a user is prompted to choose a solvent. For example, user interface 21 of microprocessor 20 could display a user interface screenshot 22 as shown in FIG. 3. Once a user chooses one of solvents AD (shown as solvent options 24 in FIG. 3), one or more prompts 25 may appear on user interface display 210. Once a user selects a solvent with option 26, the user can choose the “AUTO PRIME” option 27 to initiate pump priming, namely, step 46 of exemplary method 40.

From step 46 of exemplary method 40, exemplary method 40 proceeds to step 48, wherein a manifold valve (e.g., one of manifold valves for solvent A shown in FIG. 2) for the selected solvent is opened. Exemplary method 40 then proceeds to step 50, wherein the priming device valve (e.g., solenoid valve 15 shown in FIG. 2) is opened. Exemplary method 40 then proceeds to step 52, wherein the priming device (e.g., priming device 11 shown in FIG. 2) is activated.

From step 52, exemplary method 40 proceeds to step 54, wherein the priming device is run for a desired period of time. Typically, the priming run time is less than 120 seconds, or more typically less than 60 seconds, depending upon the fluidic configuration of the system. However, any priming run time may be inputted into the microprocessor (e.g., microprocessor 20) by a user. Exemplary method 40 then proceeds to step 56, wherein the priming device is deactivated. From step 56 of exemplary method 40, exemplary method 40 proceeds to step 58, wherein a pump priming test is initiated, for the primed pump. In one embodiment, the pump priming test may include any test that determines whether the pump is primed, such as pressure indicator, flow indicator or other sensor that detects whether liquid is present in the pump.

From step 58 of exemplary method 40, exemplary method 40 proceeds to decision block 43, wherein a determination is made whether the primed pump passed the pump priming test. If a determination is made at decision block 43 that the primed pump did not pass the pump priming test (e.g., the pump exhibits these traits: absence of pressure, absence of flow, or absence of liquid), exemplary method 40 proceeds to decision block 45, wherein a determination is made whether the primed pump has been primed a maximum number of times during the present priming cycle/run. If a determination is made at decision block 45 that the primed pump has been primed a maximum number of times during the present priming cycle/run, exemplary method 40 proceeds to step 60, wherein exemplary method 40 stops so that the pump priming system can be evaluated. If a determination is made at decision block 45 that the primed pump has not been primed a maximum number of times during the present priming cycle/run, exemplary method 40 proceeds to step 62, wherein exemplary method 40 returns to step 48 to perform another AUTO PRIME run.

Returning to decision block 43 of exemplary method 40, if a determination is made at decision block 43 that the primed pump does pass the pump priming test, exemplary method 40 proceeds to decision block 47, wherein a determination is made whether the primed pump system has another solvent pump (i.e., that has not yet been primed during this run). If a determination is made at decision block 47 that the primed pump system does not have another solvent pump (e.g., see exemplary pump priming system 10 in FIG. 1), exemplary method 40 proceeds to step 64, wherein the “DONE” option (e.g., see, done option 29 shown in FIG. 3) is shown to the user. At this time, the user (not shown) can select the done option to end the exemplary method 40 as shown in step 88. If a determination is made at decision block 47 that the primed pump system does have another solvent pump (e.g., see exemplary pump priming system 10 in FIG. 2), exemplary method 40 proceeds to step 66, wherein exemplary method 40 proceeds to decision block 49 shown in FIGS. 4B and 4C.

It should be noted that in alternative embodiments, microprocessor 20 may provide a prompt to a user (not shown) asking the user if the primed pump system has another solvent pump. In other embodiments, microprocessor 20 makes this determination without the input from a user (e.g., from solvent pump input provided previously by the user using main menu display 22 of display 210 shown in FIG. 3).

As shown in either of FIGS. 4B and 4, exemplary method 40 proceeds to decision block 49, wherein a determination is made whether to change the solvent for the next pump priming run. If a determination is made at decision block 49 to change the solvent for the next pump priming, exemplary method 40 proceeds to step 68, wherein exemplary method 40 returns to step 44, and proceeds as discussed above. If a determination is made at decision block 49 not to change the solvent for the next pump priming, exemplary method 40 proceeds to step 70, wherein exemplary method 40 returns to step 48, and proceeds as discussed above (i.e., a second manifold valve 12 for the chosen solvent will open and proceed as discussed above).

FIG. 4C depicts possible method steps when the pump priming system is part of a chromatography system. As shown in FIG. 4C, exemplary method 40 proceeds to decision block 49. If a determination is made at decision block 49 not to change the solvent for the next pump priming run, exemplary method 40 proceeds to step 72, wherein one or more run parameters are changed and/or selected in preparation for a chromatography sample run. From step 72, exemplary method 40 proceeds to step 74, wherein a sample is run through a chromatography cartridge (e.g., exemplary chromatography cartridge 30 shown in FIG. 2). During the run, a pump priming test in step 75 may be conducted to determine whether one or more of the solvent pumps is still fully primed. If a determination is made in decision block 82 that the one or more solvent pumps does pass the printing test, the chromatography run is completed in step 84, wherein the exemplary method 40 ends. If a determination is made in decision block 82 that the one or more solvent pumps does not pass the priming test, the chromatography run is paused in step 78 and the pump(s) is primed pursuant to steps 48-58.

From step 78, exemplary method 40 proceeds to decision block 86, wherein a determination is made in decision block 86 that the one or more primed solvent pumps does pass the priming test, the chromatography run is completed in step 92, wherein the exemplary method 40 ends. If a determination is made in decision block 85 that the one or more primed solvent pumps does not pass the priming test, the method proceeds to step 94 where the pump is re-primed in step 78 (until the maximum number of times is reached) or proceeds to step 76 and another solvent pump is selected and primed, or the method 40 ends if no pump(s) can be primed, and an error message is sent to the user.

In some embodiments, microprocessor 20 may provide a prompt to a user (not shown), such as prompt 25 shown in FIG. 3, asking the user if the user wants to initiate another AUTO PRIME run. If the user wants to initiate another AUTO PRIME run, the user simply selects the AUTO PRIME option 27 as discussed above. If the user does not want to initiate another AUTO PRIME run, the user simply selects the CANCEL option 28 shown in FIG. 3.

It should be understood that although the above-described pump priming systems, chromatography systems, kits, and methods are described as “comprising” one or more components or steps, the above-described pump priming systems, chromatography systems, kits, and methods may “comprise,” “consists of,” or “consist essentially of” any of the above-described components or steps of the pump priming systems, chromatography systems, kits, and methods. Consequently, where the present invention, or a portion thereof, has been described with an open-ended term such as “comprising,” it should be readily understood that (unless otherwise stated) the description of the present invention, or the portion thereof, should also be interpreted to describe the present invention, or a portion thereof, using the terms “consisting essentially of” or “consisting of” or variations thereof as discussed below.

As used herein, the terms “comprises,” “comprising,” “includes,” “including,” “has,” “having,” “contains”, “containing,” “characterized by” or any other variation thereof, are intended to encompass a non-exclusive inclusion, subject to any limitation explicitly indicated otherwise, of the recited components. For example, a pump priming system, a chromatography system, a kit, and/or method that “comprises” a list of elements (e.g., components or steps) is not necessarily limited to only those elements (or components or steps), but may include other elements (or components or steps) not expressly listed or inherent to the pump priming system, chromatography system, a kit, and/or method.

As used herein, the transitional phrases “consists of” and “consisting of” exclude any element, step, or component not specified. For example, “consists of” or “consisting of” used in a claim would limit the claim to the components, materials or steps specifically recited in the claim except for impurities ordinarily associated therewith (i.e., impurities within a given component). When the phrase “consists of” or “consisting of” appears in a clause of the body of a claim, rather than immediately following the preamble, the phrase “consists of” or “consisting of” limits only the elements (or components or steps) set forth in that clause; other elements (or components) are not excluded from the claim as a whole.

As used herein, the transitional phrases “consists essentially of” and “consisting essentially of” are used to define a pump priming system, a chromatography system, a kit, and/or a method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Further, it should be understood that the herein-described pump priming systems, chromatography systems, kits, and/or methods may comprise, consist essentially of, or consist of any of the herein-described components and features, as shown in the figures with or without any feature(s) not shown in the figures. In other words, in some embodiments, the pump priming systems, chromatography systems, kits, and/or methods of the present invention do not have any additional features other than those shown in the figures, and such additional features, not shown in the figures, are specifically excluded from the pump priming systems, chromatography systems, kits, and/or methods. In other embodiments the pump priming systems, chromatography systems, kits, and/or methods of the present invention do have one or more additional features that are not shown in the figures.

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the Spirit of the present invention and/or the scope of the appended claims.

### EXAMPLES

A pump priming system within a chromatography system as shown in FIG. 2 was prepared and used to analyze one or more samples pursuant to Examples 1 and 2 below. The system included four solvent reservoirs and two solvent pumps, a priming pump, a microprocessor, a flat panel display, a chromatography column, a fraction collector, and other system components as shown in FIG. 2.

### Example 1

In the initial setup, the pumps in the chromatography system need to be primed and the following procedure is used: Insert lines 1-4 into appropriate solvent bottles. Using the microprocessor software and display, the solvent loading page is accessed at the top menu bar by clicking Tools, Solvent Loading. A solvent line is selected (1-4 are shown) by clicking Load from the Solvent Loading box. The arrow on the right side of the solvent name box is selected, which shows a drop down menu. From this list, the name of the solvent that corresponds to the desired line is chosen. The Auto prime tab is selected and the system automatically primes the pumps. The status of the Auto prime is be displayed in the bottom left corner of the box throughout the process. When Auto prime is finished, the “Close” is selected to close the box for the current solvent line. This returns the user back to the original box showing Solvent Loading for all 4 individual lines. The user can now choose a different line to repeat the process, if necessary, or close if no priming of other lines is needed. After all the required lines are primed, all the boxes are closed and the system is now ready for the chromatography run.

### Example 2

Before a chromatography run is conducted, the system automatically checks to see if the pumps are primed. If any of the pumps fail the programmed confirm prime process, the system will stop and ask the user to prime the pump. To prime the pump, the user selects the Tools tab, and then the Solvent loading tab to select the desired solvent line used in the chromatography run. The arrow on the right side of the solvent name box is selected, which displays a drop down solvent menu. The solvent to be used in the chromatography run is selected, and then the Auto prime tab is selected whereby the system automatically primes the pumps. The status of the Auto prime progress will be displayed in the bottom left corner of the box throughout the process. When the Auto prime is finished the “Close” tab is selected to close the box, which closes all the other boxes and the system is ready for the chromatography run.

While the invention has been described with a limited number of embodiments, these specific embodiments are not intended to limit the scope of the invention as otherwise described and claimed herein. It may be evident to those of ordinary skill in the art upon review of the exemplary embodiments herein that further modifications, equivalents, and variations are possible. All parts and percentages in the examples, as well as in the remainder of the specification, are by weight unless otherwise specified. Further, any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited. For example, whenever a numerical range with a lower limit, R_{L}, and an upper limit R_{U}, is disclosed, any number R falling within the range is specifically disclosed. In particular, the following numbers R within the range are specifically disclosed: R=R_{L}+k(R_{U}−R_{L}), where k is a variable ranging from 1% to 100% with a 1% increment, e.g., k is 1%, 2%, 3%, 4%, 5%, . . . , 50%, 51%, 52%, . . . , 95%, 96%, 97%, 98%, 99%, or 100%. Moreover, any numerical range represented by any two values of R, as calculated above is also specifically disclosed. Any modifications of the invention, in addition to those shown and described herein, will become apparent to those skilled in the art from the foregoing description and accompanying drawings. Such modifications are intended to fall within the scope of the appended claims. All publications cited herein are incorporated by reference in their entirety.

What is claimed is:

1. A pump priming system comprising:
a priming device in fluid communication with (i) at least one solvent reservoir, (ii) at least one solvent pump, and (iii) at least one valve positioned between said priming device and said at least one solvent pump; and
an activation device that initiates a pump priming process, wherein fluid from said at least one solvent reservoir is moved through said at least one solvent pump via said priming device.

2. The pump priming system of claim 1, wherein said system comprises a solvent selection device positioned between each solvent reservoir and each solvent pump.

3. The pump priming system of claim 1 or 2, wherein said system comprises a priming device valve positioned between said priming device and said solvent pump.

4. The pump priming system of any one of claims 1 to 3, wherein said activation device comprises an electrical switch, a pneumatic switch, or a mechanical switch.

5. The pump priming system of any one of claims 1 to 4, wherein said at least one solvent reservoir comprises two or more solvent reservoirs.

6. The pump priming system of any one of claims 1 to 5, wherein said at least one solvent pump comprises two or more solvent pumps.

7. The pump priming system of any one of claims 1 to 6, wherein said system comprises a microprocessor with user interface, said microprocessor being programmed to (i) receive input from a user, and in response to receiving input from the user, and (ii) initiate a pump priming process.

8-11. (canceled)

12. The pump priming system of any one of claims 1 to 7, wherein said microprocessor is programmed to provide one or more prompts to the user via said user interface, the one or more prompts comprising (1) an auto prime initiation prompt, (2) a solvent selection prompt, (3) a pump priming test initiation prompt, (4) a solvent pump or reservoir selection prompt, (5) a pump priming completion prompt, or (6) any combination of prompts (1) to (5).

13. The pump priming system of any one of claims 1 to 7 and 12, wherein said priming device comprises a vacuum pump, positive displacement pump, impulse pump, valve-less pump, velocity pump or the like.

14. The pump priming system of any one of claims 1 to 7, 12 and 13, wherein said system comprises a microprocessor, said microprocessor being programmed to (i) detect whether said at least one solvent pump is not primed, and (ii) initiate a pump priming process if said at least one pump is not primed.

15. The pump priming system of claim 14, wherein said microprocessor performs steps (i) and (ii) without input from a user.

16. A chromatography system comprising the pump priming system of any one of claims 1 to 7 and 12 to 15.

17. The chromatography system of claim 16, further comprising:
at least one chromatography column in fluid communication with said at least one solvent reservoir.

18. A chromatography system according to claim 17 comprising:
at least one solvent reservoir;
at least one solvent pump, each of which is in fluid communication with said at least one solvent reservoir;
a priming device in fluid communication with (i) said at least one solvent reservoir, (it) said at least one solvent pump, and (iii) said valve positioned between each solvent reservoir and each solvent pump;
a valve positioned between said priming device and said at least one solvent pump:
an activation device that initiates a pump priming process, wherein fluid from at least one of said at least one solvent reservoir is moved through said at least one solvent pump via said priming device; and
at least one chromatography column in fluid communication with said at least one solvent reservoir.

19-32. (canceled)

33. The chromatography system of claim 18, wherein said microprocessor performs steps (i) and (ii) prior to or during a chromatography run.

34. (canceled)

35. A method of priming a pump in tire chromatography system of any one of claim 18 or 33, said method comprising:
moving a pump priming fluid from one of the at least one solvent reservoir through one of the at least one solvent pump via the priming device.

36. (canceled)

37. The method of claim 35, further comprising;
opening a first manifold valve positioned between one of the at least one solvent reservoir and a first solvent pump of the at least one solvent pump;
opening a priming device valve positioned between the priming device and the at least one solvent pump; and
activating the priming device.

38. The method of claim 35 or 37, further comprising;
deactivating the priming device after a pump priming period;
initiating a pump priming test on the first solvent pump; and
if the first solvent pump does not pass the pump priming test, repeating said steps from said opening of the manifold valve step to said deactivating step at least one time.

39. The method of claim 18, wherein said initiating a pump priming test step is performed a maximum of two times.

40. The method of any one of claims 16 to 19, wherein in response to receiving one or more inputs into a user interface of a microprocessor, initiating said method.

41-46. (canceled)

47. A kit comprising for incorporating a pump priming system into an existing chromatography system, said kit comprising:
a priming device;
a priming device valve positionable between said priming device and at least one solvent pump of the existing chromatography system; and
a software update for a microprocessor of the existing chromatography system, the software update, when loaded onto the microprocessor, enabling the microprocessor to perform the method of any one of claims 35 and 37 to 40.

48. A method of making a chromatography system, said method comprising:
incorporating the pump priming system of any one of claims 1 to 7 into the chromatography system.

49. A method of making a chromatography system according to claim 48, said method comprising:
incorporating (i) at least one solvent reservoir; (ii) at least one solvent pump, each of which is in fluid communication with the at least one solvent reservoir; (iii) a priming device in fluid communication with the at least one solvent reservoir, the at least one solvent pump; (iv) a priming device valve positioned between the priming device and the at least one solvent pump; and (v) a microprocessor with user interface into the chromatography system, wherein the microprocessor is programmed to (1) receive input from a user, and in response to receiving input from the user, (2) initiate a pump priming process, wherein fluid from at least one of the at least one solvent reservoir is moved through the at least one solvent pump via the priming device.

50-78. (canceled)
